(19) United States
(12) Patent Application Publication
(10) Pub. No.: US 2015/0073771 A1
(43) Pub. Date: Mar. 12, 2015

(54) Voice Recognition Language Apparatus

(71) Applicant: Femi Oguntuase, Houston, TX (US)

(72) Inventor: Femi Oguntuase, Houston, TX (US)

(21) Appl. No.: 14/022,616

(22) Filed: Sep. 10, 2013

(51) Int. Cl. G06F 17/27; G10L 15/00; G10L 15/26

(52) U.S. Cl. CPC G06F 17/275; G10L 15/26; G10L 15/005
USPC 704/8

(57) ABSTRACT

An electronic language aid device that is operable to provide the definition of an inputted keyword to a user in the programmed language of the device. The electronic language aid device is a portable device having a display screen and an input keypad. The device further includes voice recognition software that allows the desired keyword to be input onto the device via oral instructions in addition to using the input keypad. The electronic language aid device utilizes a keyword database and a language database wherein the words listed therein have an alphanumeric string assignment. Subsequent a desired keyword being entered into the device and being identified in the language database, the electronic language aid device provides the word and phonetic pronunciation via the display screen and further provides the definition to a user via an audio speaker.

### PRIORITY UNDER 35 U.S.C SECTION 119(e) & 37 C.F.R. SECTION 1.78

This nonprovisional application claims priority based upon the following prior United States Provisional Patent Application entitled: Voice Recognition Dictionary, Application No. 61/699,347, filed Sep. 11, 2012, in the name of Femi Oguntuase, which is hereby incorporated by reference for all purposes.

### FIELD OF THE INVENTION

The present invention relates generally to language aid devices, more specifically but not by way of limitation, an electronic language aid device that receives inputs from a user wherein the electronic aid device subsequently provides the correct spelling of the word, the phonetic pronunciation and the definition of the word.

### BACKGROUND

Learning a language, whether it be a primary language or a secondary language is a long a tedious process. Every language has its own alphabet and grammatical structure that must be learned in order to successfully speak the language. One important part of learning a language is to learn words and in particular the spelling and the definition of the words. Having a vast knowledge of descriptive words and subject words in a given language will help the person excel at both oral and written communication in the language.

One problem encountered by many people, especially adults, as they begin to learn a language is the ability to access a dictionary or the like in order to investigate what a particular word means or the correct pronunciation. Reference books such as dictionaries are cumbersome to carry and do not provide assistance if a user is unsure of how to spell the word that they are attempting to identify. A user can spend a significant amount of time perusing through pages attempting to find a word that they believe is the word they are attempting to learn. Additionally, if a user has not yet learned to read well in the language a conventional dictionary or similar reference tool whether a hardcopy or an online database is of little use.

Another issue with reference tools such as dictionaries is their inability to assist a user in the correct pronunciation. While some reference tools provide phonetic spellings of the words, unless a user is proficient in the language the reference tool is written in it does not provide the assistance that is required by the user.

A further problem with conventional language reference tools is that they are inadequate in providing assistance to a user that is visually impaired. While reference tools in braille are available, during the learning phase of a language these reference tools have proven to be ineffective in assisting a user in the development of the speaking of the language.

Accordingly, there is a need for a electronic language aid device that assists a user in the learning of words of a language wherein the user can input the words either orally or via keypad and wherein the electronic aid device provides output to the user in both a visual and an audial format.

### SUMMARY OF THE INVENTION

It is the object of the present invention to provide an electronic language aid device that is operable to teach the user the correct definition of a word in the programmed language.

Another object of the present invention is to provide an electronic language aid device that is operable to teach the user the correct spelling of an inputted word.

A further object of the present invention is to provide an electronic language aid device that is further operable to provide the phonetic pronunciation of the inputted word.

Still another object of the present invention is to provide an electronic language aid device that is configured to receive an inputted word either via an audio microphone or via a keypad.

An additional object of the present invention is to provide an electronic language aid device that is operable to provide the user the inputted word in both a visual and an audial format.

Yet a further object of the present invention is to provide an electronic language aid device that is operable to provide a choice of more than one reference word related to the inputted word upon being unable to determine with certainty the inputted word.

Still a further object of the present invention is to provide an electronic language aid device that is operable to provide the definition and spelling of a word in the programmed language that is portable and easy to use.

To the accomplishment of the above and related objects the present invention may be embodied in the form illustrated in the accompanying drawings. Attention is called to the fact that the drawings are illustrative only. Variations are contemplated as being a part of the present invention.

### BRIEF DESCRIPTION OF THE DRAWINGS

A more complete understanding of the present invention may be had by reference to the following Detailed Description when taken in conjunction with the accompanying Drawings wherein the drawings provide schematic views of a preferred embodiment of the present invention only and do not serve to limit the scope of the present invention.

FIG. 1 is a schematic diagram of the present invention; and

FIG. 2 is a flowchart showing the operation of the dictionary retrieval processing.

### DETAILED DESCRIPTION

Referring now to the drawings submitted herewith, wherein various elements depicted therein are not necessarily drawn to scale and wherein through the views and figures like elements are referenced with identical reference numerals, there is illustrated an electronic language aid device 100 constructed according to the principles of the present invention.

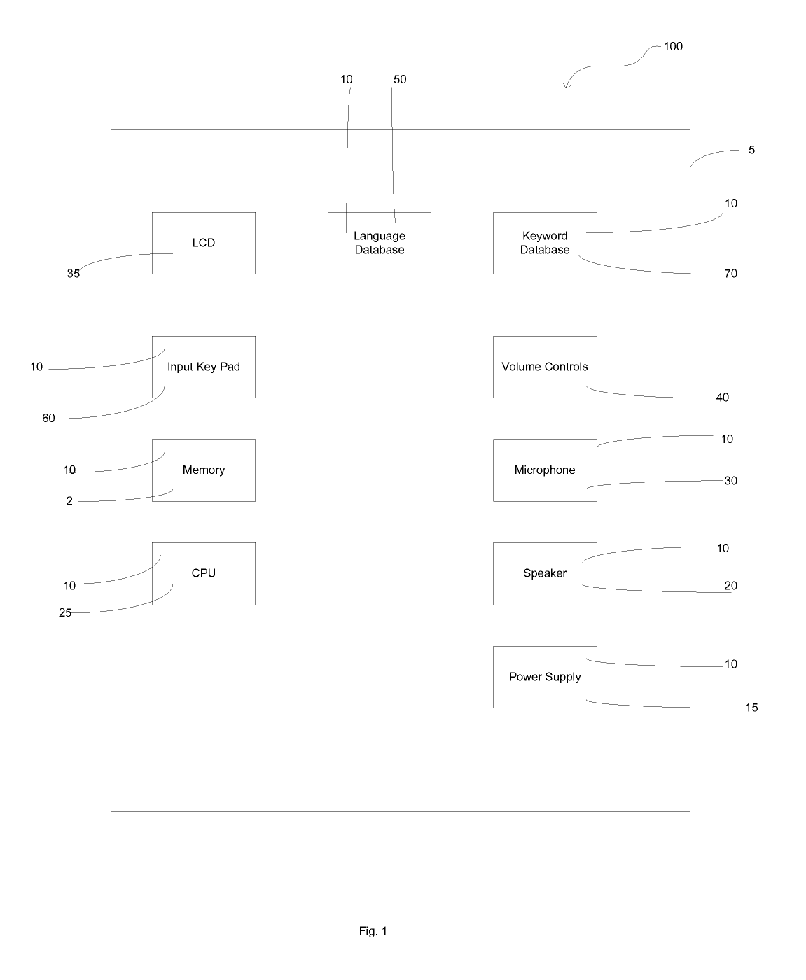

Referring in particular to FIG. 1, a schematic diagram of the electronic language aid device 100 is illustrated therein. The electronic aid device 100 includes a housing 5 that is manufactured from a suitable durable material such as but not limited to plastic. It is contemplated within the scope of the present invention that the housing 5 could be formed in numerous different sizes and shapes. The electronic language aid device 100 is designed to be portable and as such the housing 5 will be constructed to facilitate the easy carrying of the electronic language aid device 100.

Disposed within the housing 5 are a plurality of components 10 operable to provide the functionality of the electronic language aid device 100. A power supply 15 is disposed within the housing 5 and is operable to provide the necessary power to operate the electronic language aid device 100. It is contemplated within the scope of the present invention that the power supply 15 could be numerous different types of power supplies such as but not limited to alkaline or rechargeable lithium ion batteries. A speaker 20 is present and is operably coupled to the power supply 10 and CPU 25. The CPU 25 is a conventional central processing unit containing the necessary electronics to receive, store, transmit and manipulate data. The speaker 20 is a conventional audio speaker and is operable to broadcast the data output of the electronic language aid device 100. A microphone 30 is disposed within the housing 5 and is a conventional microphone that functions to receive audio signals from a user. The microphone 30 is operably coupled to the CPU 25 in order to facilitate the processing of the orally input keyword. The microphone 30 is utilized to facilitate the keyword input wherein the user will speak into the microphone 30 the desired keyword for which the user would like to receive the keyword parameters thereof. The keyword parameters that are provided to the user are a displayed spelling of the word via the LCD screen 35, the displayed phonetic pronunciation and the definition of the keyword. Volume controls 40 are present and operably intermediate the speaker 20 and power supply 15 and are conventional controls that allow a user to adjust the volume of the speaker 20. The LCD screen 35 is a conventional LCD screen and is disposed on the outside of the housing 5. The LCD screen 35 functions to display the keyword parameters previously mentioned herein. It is contemplated within the scope of the present invention that the LCD screen 35 could be manufactured in numerous different sizes. An input keypad 60 is integrally built into the housing 5 and facilitates the entry of a keyword into the electronic language aid device 100. The input keypad 60 allows for a second mode of entry of a keyword in addition to the audio input via the microphone 30. The input keypad 60 is contemplated to either be configured as a full QWERTY style keypad or be configured as a numeric keypad having a plurality of letters associated with each key such as a conventional cellular phone keypad. It is further contemplated within the scope of the present invention that the input keypad 60 could be a touch screen integrated into the LCD screen 35 or a separate keypad having buttons.

Disposed within the housing 5 is the language database 50 and a keyword reference database 70. The language database 50 and the keyword reference database 70 are operably coupled to the CPU 25 and are physically embodied as either as a ROM or RAM memory device. The keyword reference database 70 contains a listing of all of the words of the programmed language along with a string assignment for each of the words. The language database 50 has stored therein the same word listing as the keyword reference database 70 along with the string assignment and further includes the keyword parameters for each word in the programmed language such as but not limited to, English. The string assignment utilizes a character string to classify the word type and is further utilized by the CPU 25 to categorize associative words. By way of example but not by limitation, if the word dubious is stored in the language database 50 and the reference keyword database 70, the word dubious has assigned thereto a string assignment having multiple characters that will identify the word and further identify the category of the word. Continuing with the example, the language database 50 will further contain the word, ambiguous, wherein the word, ambiguous, shares at least one character of the string assignment with the word, dubious. This process of string assignment allows for the CPU 25 to identify categories of words that are similar in meaning and as later discussed herein will utilize the string assignment to provide suggested alternative reference keyword if the inputted keyword is not found in the reference keyword database 70.

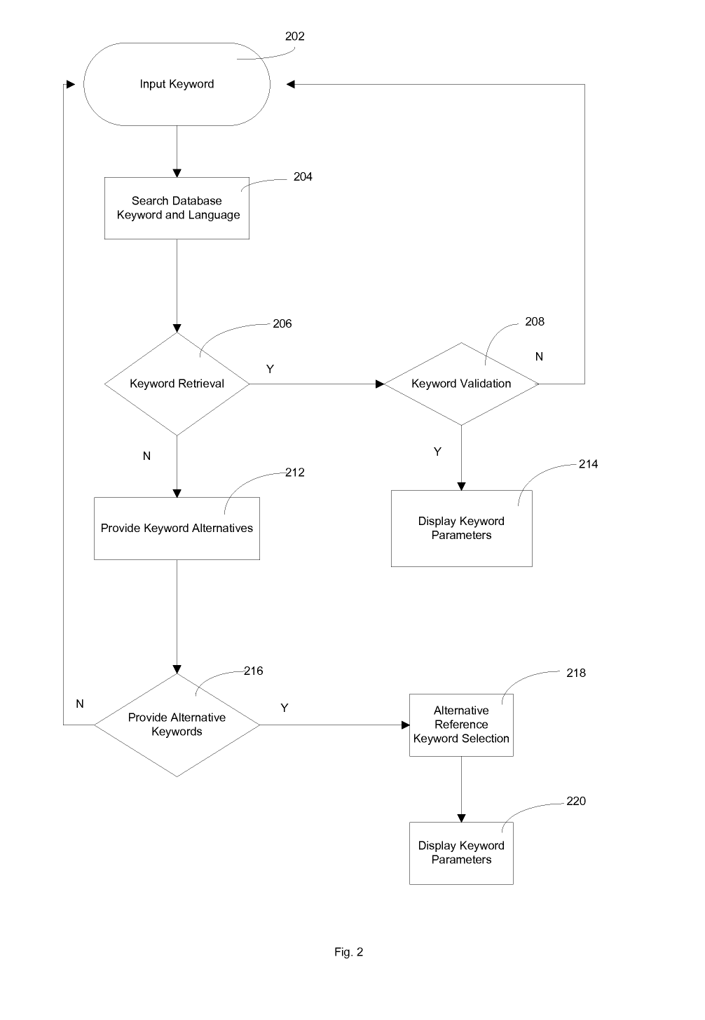

Referring in particular to FIG. 2, a flowchart of the operational processing of the electronic language aid device 100 is illustrated therein. In step 202, a user will input a keyword for which the user would like to receive the keyword parameters. The keyword can be inputted via a first mode or a second mode. In the first mode, the keyword is inputted into the electronic language aid device 100 via the microphone 30 wherein the user speaks the keyword into the microphone 30. In a second mode, the keyword is inputted into the electronic language aid device 100 utilizing the input keypad 60. Subsequent the keyword being inputted into the electronic language aid device 100, the CPU 25 commences processing the received input keyword by initially referencing the keyword database 70 so as to identify the inputted word and locate the string assignment for the inputted keyword. The advantage of the string assignment allows the inputted keyword to be classified in several different subcategories which enables improved results if the identical inputted keyword is not found in the keyword database 70. This initial step is executed by utilizing voice recognition software that is stored in the memory 2 wherein the voice recognition software is operable to convert the orally inputted keyword into the characters of the programmed language. It is contemplated within the scope of the present invention that more than one memory 2 could be disposed within the housing 5. Ensuing the voice to character conversion the CPU 25 will search the keyword reference database 70 for a word that matches the characters of the inputted keyword. Once the inputted keyword is initially matched to a reference word in the keyword reference database 70, the CPU 25 identifies the associated string assignment for the reference keyword. Subsequent the identification of the string assignment for the reference keyword the CPU 25 initializes the searching of the language database 50 for the reference keyword in an effort to locate the string assignment that identically matches the string assignment of the identified reference keyword, illustrated as step 204. Ensuing the search of the language database 50, in step 206 the CPU 25 determines if the inputted keyword is matched to a reference keyword in the language database 50. A one hundred percent match of all of the characters of the string assignment associated with each word in the language database 50 must occur for the keyword parameters to be displayed. Those skilled in the art will recognize that the string assignment could be numerous different lengths and utilize various alphanumeric characters. In step 208, if the string assignment of the inputted keyword identically matches the string assignment of the reference keyword in the language database 50 then the user is prompted either via the speaker 20 or via the LCD screen 35 to validate the reference keyword is accurate. If the reference keyword is validated in step 208 as being correct, the electronic language aid device 100 proceeds to step 214 and displays the keyword parameters on the LCD screen 35. Additionally, the keyword parameters are provided in an audio format simultaneously to the user.

In step 212, if the inputted keyword cannot be identically matched to a reference keyword via the string assignment technique, the electronic language aid device 100 will provide via the LCD screen 35 a list of alternative reference keywords based on a partial string assignment analysis. As the CPU 25 is cross-referencing the inputted keyword with the keyword reference database, each character of the string assignment is matched in order. As the string assignment for the reaches an eighty percent match for the inputted keyword and the reference keyword, those reference keywords are temporarily tagged. Upon the CPU 25 being unable to find an identical string assignment match for the inputted keyword and the reference keyword, the electronic language aid device 100 will display the previously tagged reference keywords that had at least an eighty percent match of string assignment.

In step 216, the user will review the provided alternative reference keywords in order to determine if on of the displayed alternative reference keywords is acceptable. If no displayed alternative reference keyword is displayed, the user will proceed back to step 202, and input a desired keyword. If one of the displayed alternative reference keywords is acceptable to the user, the user will select that alternative reference keyword in step 218. Subsequent to step 218, the electronic language aid device 100 will display the keyword parameters for the selected alternative reference keyword. It is contemplated within the scope of the present invention that the keyword parameters could include additional information in conjunction with the keyword parameter information previously listed herein. More specifically but not by way of limitation, the keyword parameters could further include the use of the inputted keyword in a sentence.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An electronic language aid device comprising:
a housing, said housing being of sufficient size so as to be easily portable;
a display screen;
a central processing unit, said central processing unit being disposed within said housing, said central processing unit containing the necessary electronics to store, receive, transmit and manipulate data;
at least one memory device, said at least one memory device operably coupled to said central processing unit;
a keyword database, said keyword database being stored in said at least one memory device, said keyword database being programmed with all of the reference words of a single language;
a language database, said language database being programmed with all of the words present in the keyword database, said language database further including keyword parameters for each of the words programmed therein; and
wherein the electronic language aid has a first mode and a second mode to receive an inputted keyword.

2. The electronic language aid device as recited in claim 1, and further including a voice recognition software, said voice recognition software operably controlled by said central processing unit, said voice recognition software operable to facilitate said first mode.

3. The electronic language aid device as recited in claim 2, wherein in said first mode, a user will speak to input a keyword into the electronic language aid device.

4. The electronic language aid device as recited in claim 3, and further including a keypad, said keypad integrally formed with said housing, said keypad operable to facilitate the entry of a keyword into the electronic language aid device, wherein said second mode consists of utilizing said keypad to enter a keyword in the electronic language aid device.

5. The electronic language aid device as recited in claim 4, wherein each word programmed into the keyword database and the language database has an allocated string assignment, wherein the string assignment consists of a multiple character alphanumeric code.

6. The electronic language aid device as recited in claim 5, wherein the inputted keyword must have a string assignment that is at least eighty percent equivalent to that of the reference keyword in order to be output to the user

7. The electronic language aid device as recited in claim 6, wherein said keyword parameters include the following: spelling of the keywords, phonetic pronunciation of the keywords and the definition of the keywords.

8. An electronic language aid device operable to provide the definition of an inputted keyword comprising:
a housing, said housing being of sufficient size so as to be easily portable;
a display screen;
an audio microphone, said audio microphone operable to receive an inputted keyword;
a keypad;
a central processing unit, said central processing unit being disposed within said housing, said central processing unit containing the necessary electronics to store, receive, transmit and manipulate data;
at least one memory device, said at least one memory device operably coupled to said central processing unit;
a voice recognition software, said voice recognition software operable to convert a spoken word into text format so as to be processed by said central processing unit;
a keyword database, said keyword database being stored in said at least one memory device, said keyword database being programmed with all reference words of a single language, wherein the programmed known words are further allocated with a string assignment;
a language database, said language database being programmed with all of the reference words present in the keyword database and wherein the words present in the language database further include the string assignment, said language database further including keyword parameters for each of the words programmed therein;
wherein the electronic language aid is operable to receive an inputted keyword in both a first mode and a second mode.

9. The electronic language aid device as recited in claim 8, wherein said keyword parameters of the language database include the following: spelling of the keywords, phonetic pronunciation of the keywords and the definition of the keywords.

10. The electronic language aid device as recited in claim 9, wherein said first mode is operable to receive an inputted keyword via the audio microphone, subsequent receipt of an inputted keyword in said first mode said voice recognition software being operable to convert the received audio signal to text for transmission to said central processing unit.

11. The electronic language aid device as recited in claim 10, wherein in said second mode the electronic language aid device is operable to receive an inputted keyword via said keypad.

12. The electronic language aid device as recited in claim 11, wherein the keyword parameters are provided to a user ensuing the string assignment of the inputted keyword matching the string assignment of a reference word in said language database.

13. The electronic language aid device as recited in claim 12, wherein at least one alternative reference word is provided to a user ensuing the inputted keyword having a string assignment that is at least eighty percent equal to a string assignment of a reference word.

14. The electronic language aid device as recited in claim 13, wherein the string assignment is comprised of an alphanumeric code having multiple characters.

15. A portable electronic language aid device that is operable to receive an inputted keyword and provide a definition to a user for the inputted keyword comprising:
a housing, said housing being of sufficient size so as to be easily portable;
a display screen;
an audio microphone, said audio microphone operable to receive an inputted keyword;
a speaker;
a keypad;
a central processing unit, said central processing unit being disposed within said housing, said central processing unit containing the necessary electronics to store, receive, transmit and manipulate data;
a memory chip, said memory chip operably coupled to said central processing unit;
a voice recognition software, said voice recognition software operable to convert a spoken word into text format so as to be processed by said central processing unit;
a keyword database, said keyword database being stored in said at least one memory device, said keyword database being programmed with all reference words of a single language, wherein the programmed known words are further allocated with a string assignment;
a language database, said language database being programmed with all of the reference words present in the keyword database and wherein the words present in the language database further include the string assignment identical to the string assignment associated with each word of the keyword database, said language database further including keyword parameters for each of the words programmed therein;
wherein the electronic language aid is operable to receive an inputted keyword in both a first mode utilizing the keypad and a second mode utilizing the audio microphone.

16. The electronic language aid device as recited in claim 15, wherein the language database further includes keyword parameters, said keyword parameters including the phonetic pronunciation and spelling of the keywords.

17. The electronic language aid device as recited in claim 16, wherein said string assignment includes a plurality of alphanumeric characters and is operable to categorize each keyword.

18. The electronic language aid device as recited in claim 17, wherein at least one alternative reference word is provided to a user ensuing the inputted keyword having a string assignment that is at least eighty percent equal to a string assignment of a reference word.

19. The electronic language aid device as recited in claim 18, wherein the keyword database and the language database are programmed in a single language.

20. The electronic language aid device as recited in claim 19, and further including a rechargeable power supply, said rechargeable power supply operable to provide power to the electronic language aid device.
